(19) United States
(12) Patent Application Publication
(10) Pub. No.: US 2021/0192813 A1
(43) Pub. Date: Jun. 24, 2021

(54) METHODS AND SYSTEMS FOR FACILITATING GENERATION OF NAVIGABLE VISUALIZATIONS OF DOCUMENTS

(71) Applicant: Catachi Co. DBA Compliance.ai, San Francisco, CA (US)

(72) Inventors: Danielle Lee Deibler, San Francisco, CA (US); Brendan Callahan, San Francisco, CA (US); Christopher Walker, San Francisco, CA (US)

(21) Appl. No.: 17/127,089

(22) Filed: Dec. 18, 2020

Related U.S. Application Data
(60) Provisional application No. 62/949,585, filed on Dec. 18, 2019.

(51) Int. Cl. G06T 11/20; G06K 9/00; G06F 3/01; G06F 16/93; G06F 16/904

(52) U.S. Cl. CPC G06T 11/206; G06K 9/00483; G06T 2200/24; G06F 16/93; G06F 16/904; G06F 3/017

(57) ABSTRACT

Disclosed herein is a method for facilitating generation of navigable visualizations of documents, in accordance with some embodiments. Accordingly, the method may include receiving, using a communication device, a primary document from a user device, analyzing, using a processing device, the primary document, retrieving, using a storage device, a reference document based on the analyzing, analyzing, using the processing device, the reference document based on the primary document, identifying, using the processing device, a relationship between the primary document and the reference document based on the analyzing of the reference document, establishing, using the processing device, a link between the primary document and the reference document based on the relationship, generating, using the processing device, a visualization of the primary document, the reference document, and the link based on the primary document, the reference document, and the link, and transmitting, using the communication device, the visualization to the user device.

The current application claims a priority to the U.S. Provisional Patent application Ser. No. 62/949,585 filed on Dec. 18, 2019.

### FIELD OF THE INVENTION

Generally, the present disclosure relates to the field of data processing. More specifically, the present disclosure relates to methods and systems for facilitating the generation of navigable visualizations of documents.

### BACKGROUND OF THE INVENTION

Graphical representation of data has multiple advantages. For instance, a graphical representation of data allows to display large sets of data and compare multiple sets of data at once. For instance, graphical representations may be useful in displaying a multitude of data and details that would need more space to display, and more time for analysis and explanation.

Accordingly, multiple systems may be used for generating graphical representations, specifically for the generation of two-dimensional graphical grid representations of the treatment of a document. Further, current technologies may generate a navigable visual representation of legal documents including attributes such as a year, jurisdiction, etc. including color-coding of the attribute values associated with the legal documents to improved visual representation. However, current technologies do not include the generation of navigable citation-based graph UI for regulatory documents comprising circles and lines graph visualization of document co-citation. Further, current technologies do not include the process of encoding of document attributes such as genre, jurisdiction, and impact using visual cues such as shape, size, and color. Further, current technologies do not include the feature of identification of links between regulatory documents based on natural language processing techniques and providing visualization for inspecting the impact and similarity of all the documents that may be linked to a document of interest. Further, current technologies do not allow for visual representations to dynamic, including changes in representations based on a change in relevance between regulatory documents. Further, current technologies do not allow visual representations to be customizable by individuals through preset themes, or by providing specific inputs to bring about desired changes in visualizations. Further, current technologies do not allow for visual representations to be rendered in 3D instead of 2D and navigated through user input. Further, current technologies do not allow for visual representations to be automatically updated based on updates and changes that may have been made in the documents.

Therefore, there is a need for improved methods and systems for facilitating the generation of navigable visualizations of documents that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating generation of navigable visualizations of documents, in accordance with some embodiments. Accordingly, the method may include a step of receiving, using a communication device, at least one primary document from at least one user device. Further, the method may include a step of analyzing, using a processing device, the at least one primary document. Further, the method may include a step of retrieving, using a storage device, at least one reference document based on the analyzing of the at least one primary document. Further, the method may include a step of analyzing, using the processing device, the at least one reference document based on the at least one primary document. Further, the method may include a step of identifying, using the processing device, at least one relationship between the at least one primary document and the at least one reference document based on the analyzing of the at least one reference document. Further, the method may include a step of establishing, using the processing device, at least one link between the at least one primary document and the at least one reference document based on the at least one relationship. Further, the at least one link connects the at least one primary document and the at least one reference document. Further, the at least one link facilitates navigating between the at least one primary document and the at least one reference document. Further, the method may include a step of generating, using the processing device, at least one visualization of the at least one primary document, the at least one reference document, and the at least one link based on the at least one primary document, the at least one reference document, and the at least one link. Further, the method may include a step of transmitting, using the communication device, the at least one visualization to the at least one user device. Further disclosed herein is a system for facilitating generation of navigable visualizations of documents, in accordance with some embodiments. Accordingly, the system may include a communication device configured for receiving at least one primary document from at least one user device. Further, the communication device may be configured for transmitting at least one visualization to the at least one user device. Further, the system may include a processing device communicatively coupled with the communication device. Further, the processing device may be configured for analyzing the at least one primary document. Further, the processing device may be configured for analyzing at least one reference document based on the at least one primary document. Further, the processing device may be configured for identifying at least one relationship between the at least one primary document and the at least one reference document based on the analyzing of the at least one reference document. Further, the processing device may be configured for establishing at least one link between the at least one primary document and the at least one reference document based on the at least one relationship. Further, the at least one link connects the at least one primary document and the at least one reference document. Further, the at least one link facilitates navigating between the at least one primary document and the at least one reference document. Further, the processing device may be configured for generating the at least one visualization of the at least one primary document, the at least one reference document, and the at least one link based on the at least one primary document, the at least one reference document, and the at least one link. Further, the system may include a storage device communicatively coupled with the processing device. Further, the storage device may be configured for retrieving the at least one reference document based on the analyzing of the at least one primary document.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating generation of navigable visualizations of documents, in accordance with some embodiments.

FIG. 3 is a flowchart of a method for facilitating the generation of navigable visualizations of documents, in accordance with some embodiments.

FIG. 4 is a flowchart of a method for determining at least one document visual cue for facilitating the generation of the navigable visualizations of the documents, in accordance with some embodiments.

FIG. 5 is a flowchart of a method for determining at least one link visual cue for facilitating the generation of the navigable visualizations of the documents, in accordance with some embodiments.

FIG. 6 is a flowchart of a method for determining at least one first document visual cue for facilitating the generation of the navigable visualizations of the documents, in accordance with some embodiments.

FIG. 7 is a flowchart of a method for determining a closeness between the at least one primary document and the at least one reference document for facilitating the generation of the navigable visualizations of the documents, in accordance with some embodiments.

FIG. 8 is a flowchart of a method for generating at least one modified visualization for facilitating the generation of the navigable visualizations of the documents, in accordance with some embodiments.

FIG. 9 is a flowchart of a method for facilitating the generation of visualizations for the navigable citation-based graph UI for regulatory documents, in accordance with some embodiments.

FIG. 10 is an illustration of a visualization of a navigable citation-based graph UI of regulatory documents, in accordance with some embodiments.

FIG. 11 is an illustration of a visualization of a navigable citation-based graph UI of regulatory documents, in accordance with some embodiments.

FIG. 12 is an illustration of a visualization of a navigable citation-based graph UI of regulatory documents, in accordance with some embodiments.

FIG. 13 is an illustration of a visualization of a document, in accordance with some embodiments.

FIG. 14 is an illustration of a visualization of a document, in accordance with some embodiments.

FIG. 15 is an illustration of a visualization of a document, in accordance with some embodiments.

FIG. 16 is an illustration of a visualization of a document, in accordance with some embodiments.

FIG. 17 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating generation of navigable visualizations of documents, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating the generation of navigable visualizations of documents. Further, the disclosed system may be configured for facilitating the generation of visualizations for a navigable citation-based graph UI for regulatory documents comprising circles and lines graph visualization of document co-citation that encodes document attributes such as genre, jurisdiction, and impact using visual cues such as shape, size, and color. Further, the disclosed system may be configured for identifying links between regulatory documents based on NLP and providing visualization for inspecting the impact and similarity of all the documents linked to a given one. The visualizations for the navigable citation-based graph UI may represent the links between the regulatory documents. Regulatory documents may include, but may not be limited to legal documents including regulations, and laws, medical documents including research papers, and case studies, and documents related to any other field of study or research. A user may access the citation-based UI and view the regulatory documents, along with the linked documents. Further, the regulatory documents may be retrieved and accessed from external connected databases. The databases may include legal databases, medical databases, engineering, and architectural databases, and so on.

Further, the disclosed system may include a user device that a user may use to access the citation-based graph UI. The user device may be a mobile device such as, but not limited to, a smartphone, or a computer tablet, or a computing device like a personal computer, or a laptop. The user device may include a communication device configured to communicate over a communication network such as, but not limited to, a cellular network, a satellite network, a personal area network, Bluetooth, Internet, and so on. Further, the user device may include sensors. The sensors may include, but may not be limited to a GPS sensor, a camera, a microphone, accelerometer, gyroscope, and so on.

Further, the disclosed system may allow users to register and create user profiles on an online platform. Accordingly, the user profiles may include information about the name, age, gender, location, and so on about the users. Further, the user profiles may include information about the profession of the users, such as a lawyer, doctor, and so on. Further, the profession of the users may be specified to include the specialization, for instance, a lawyer may specialize in mergers and acquisitions, and a doctor may specialize in neurology.

The visualizations for the navigable citation-based graph UI for regulatory documents may be comprised of circles and line graph visualization. The citation-based graph may be created by analysis of documents, and determination of co-citations that the documents may include. Further, the citations and references in documents may be analyzed for context to determine the category of citations, and to determine the similarity and impact of documents on linked documents. The links between regulatory documents may be recognized and analyzed based on natural language processing.

Further, the visualizations for the navigable citation-based graph UI for regulatory documents may encode document attributes such as genre, jurisdiction, and impact in visualizations using visual cues such as shape, size, and color.

Further, the visualizations for the navigable citation-based graph UI for regulatory documents may be dynamic. The visualizations may change based on the documents being displayed, and the relationship between documents, including the number of citations that the documents may include. For instance, a visualization for the citation-based graph UI may include circles representing various regulatory documents.

Accordingly, the circles representing the different documents may be differently colored based on the type of documents. For instance, the documents that may be of primary interest to the user may be of a particular color and other reference documents that may include citations and references to and from the documents may be colored differently. Further, the primary documents may be connected to reference documents through lines.

The thickness and length of the lines may represent the number of citations, and closeness in terms of content, and category of the content of the documents.

Further, the visualizations for the navigable citation-based graph UI for regulatory documents may be customizable. Further, the user may choose the visual representations of the citation-based graph UI and may customize the visualization based on the ease of viewing the graph-based UI. For instance, the user may customize the shape of the icons that may be used to represent the primary documents, reference documents, and the connecting links between the primary documents and reference documents. Further, the user may be able to choose a theme of representation. Further, the theme may include basic settings such as the color scheme, and types of icons, and shape to represent the primary documents, and reference documents.

Further, the visualizations for the navigable citation-based graph UI for regulatory documents may be 3D representations instead of 2D. For instance, the primary document may be represented by a sphere, which may be surrounded by multiple other spheres representing the reference documents that may contain citations to the primary documents. Further, the spheres representing the reference documents may be at different distances to the sphere representing the primary document. The distance may represent the closeness in category and content between the primary document and the reference documents. Further, the spheres representing the reference documents may be connected to the sphere representing the primary document through lines. The thickness of the connecting lines may represent the number of citations and references that the reference documents may contain the primary documents. Further, the color of the spheres may depict the category of the documents. Further, the 3D visualization may also include multiple layers. The layers may include reference documents, and the layers nearest, and adjacent to the layer containing the primary document may represent reference documents that may include most citations and references to the primary documents and may be categorically most similar. Further layers may represent other reference documents containing lesser citations, and reference documents that may be less similar to the primary document.

Further, the visualizations for the navigable citation-based graph UI for regulatory documents may be updated in real-time. The visualizations may change to incorporate any changes or updates that may have been made to the documents, including changes in the content, references, citations, and the categories of the documents. For instance, if a reference document is updated, with changes made in the content including the citations, and references, the visualizations may change to include the changes made in the document. Therefore, the documents may be constantly analyzed to monitor any changes that may be made.

Further, the visualizations for the navigable citation-based graph UI for regulatory documents may be immersive and may be viewed using VR headsets. Accordingly, the disclosed system may include an external VR headset that may be used to view the visualizations for the navigable citation-based graph UI for regulatory documents. Further, the disclosed system may include additional sensors, such as cameras, to monitor the motion of the user. The user may perform certain gestures that may be used to navigate through the visualizations for the navigable citation-based graph UI for regulatory documents. Accordingly, the gestures and motions of the user may be recorded and analyzed to determine how the user may be navigating through the immersive visualizations.

Further, the disclosed system may use a connected-graph-based technique for automatic topic classification, relationships, and discovery. Further, the disclosed system may be configured for identification, classification, and resolution of document citations in the text using a novel blend of learned, manual, and rule-based approaches. Further, the disclosed system may be configured for generating a navigable citation-based graph UI for regulatory documents comprising circles and lines graph visualization of document co-citation that encodes document attributes such as genre, jurisdiction, and impact using visual cues such as shape, size, and color. Further, the disclosed system may be configured for identifying links between regulatory documents based on NLP and providing visualization for inspecting the impact and similarity of all the documents linked to a given one.

Further, the disclosed system may use a combination of summarization techniques we have developed a proprietary model for summarizing documents related to regulation. Further, the disclosed system may be configured for generating a text summary of a document (e.g. regulatory document) based on scoring the value of each sentence for its use in a text summary of the document, as validated by the feedback of expert judges and other ground-truth metrics. Further, the disclosed system may be configured for assigning weights to sentences for summarization based on topics, genres, rates of compression, or other corpus heterogeneity. Further, the disclosed system may be configured for generating summaries of multiple documents (e.g. regulatory documents) based on important links and similarities between the concepts, references, and documents; and compressing these concepts down to the most important facts; and expressing those facts in the form of natural English sentences. Further, the disclosed system may be configured for generating summaries of multiple documents in the form of tables and charts based on citation analysis.

Further, Variable-length summaries are constructed via an iterative 1-best sentence extraction process leveraging, among other features: depth in the document, depth in the section, topic-relevance, topic-diversity, discourse coherence, “slot” coverage (e.g. “respondent”, “violation”, “penalty” and “enforcement action type” for regulatory enforcement documents), summary “cue score” (i.e. the similarity of the sentence to summaries previously seen), and other proprietary document and sentence understanding-related features. The key distinguishing features of the disclosed system are: (1) the ability to vary the “compression rate” of the summarization engine to accommodate various summarization needs and (2) a suite of re-weighting strategies sensitive to this variability and optimized toward summaries that gracefully balance topic relevance, subtopic diversity and contextual coherence. Both word scoring and sentence selection weights are “learned” from text data using a variety of supervised and unsupervised methods familiar within ML.

Further, using a combination of summarization techniques, the disclosed system may be configured for summarizing documents related to regulation. Further, extractive summarization associated with the disclosed system may include the collection and application of sentence-ranking data regarding regulatory compliance documents.

Further, using a narrowly-tailored word- and sentence-segmentation process associated with the disclosed system, the disclosed system may provide text summaries that are “compressions” of the original text—achieved via sentence extraction. Further, the novel text summaries may be assembled from contents of the document(s) being summarized by scoring the value of each sentence for its use in a text summary of the document, as validated by the feedback of expert judges and other ground-truth metrics. A weighted-feature approach to sentence scoring lays the foundation for a number of learned and hand-tuned strategies that can be effectively tuned to accommodate different topics, genres, rates of compression, or other corpus heterogeneity. Further, the disclosed system may follow best practices and instrumentation for the capture of sentence ranking preferences from domain experts. Further, the disclosed system may follow best practices and instrumentation for the evaluation of summary proposals. Further, the disclosed system may be configured for genre-specific sentence segmentation and classification. Further, the disclosed system may be configured for genre-specific word tokenization sensitive to domain names and citation patterns. Further, the disclosed system may be associated with genre-specific weighted-feature scoring algorithms for sentence ranking (and iterative re-ranking) to aid in sentence selection for summary construction. Further, abstractive summarization associated with the disclosed system may include a novel slot-driven document and multi-document summarizer producing textual summaries. Using scrapers, crawlers, and Natural Language Processing techniques, the disclosed system provides text summaries that represent the distillation of the content of regulatory documents into a newly-created passage of text reflecting the most important themes or topics in those documents. Further, the disclosed system may identify key concepts and references in the documents; then we establish the important links and similarities between the concepts, references, and documents. Further, the disclosed system may compress these concepts down to the most important facts and express those facts in the form of natural English sentences. Further, the disclosed system may be configured for identification, classification, and resolution of document citations in the text using a novel blend of learned, manual, and rule-based approaches. Further, the disclosed system may be configured for the extraction, classification, and resolution (or disambiguation) of a number of genre-specific attributes including names of people and organizations, amounts of money, legal actions and outcomes, dates, requirements, etc. Further, the disclosed system may be configured for algorithms and models for the construction of text passages using the information provided in genre-specific slots filled by the items extracted from the text(s) being summarized.

Further, the disclosed system may be configured for numeric summarization. Further, the disclosed system may be associated with a slot-driven document and multi-document summarizer producing tabular and chart summaries. Using scrapers, crawlers, and Natural Language Processing techniques, the disclosed system may provide numerical summaries that represent the distillation of the content of regulatory documents into a newly-created passage of text reflecting the most important themes or topics in those documents. Further, the disclosed system may be configured for identifying key concepts and references in the documents; then we establish the important links and similarities between the concepts, references, and documents; then compressing these concepts down to the most important facts and express those facts in the form of tables and charts of statistical summaries. Further, the disclosed system may be configured for the identification, classification, and resolution of document citations in the text using a novel blend of learned, manual, and rule-based approaches. Further, the disclosed system may be configured for the extraction, classification, and resolution (or disambiguation) of a number of genre-specific attributes including names of people and organizations, amounts of money, legal actions and outcomes, dates, requirements, etc. Further, the disclosed system may be associated with algorithms and models for the construction of tables and charts using the information provided in genre-specific slots filled by the items extracted from the text(s) being summarized.

Further, the disclosed system may be configured for the surfacing and automatic classification of regulatory documents. Further, the disclosed system may be configured for generating topic classification (or filters) of documents (e.g. regulatory documents) based on a blend of expert task specification, assessment, human-driven real-time classification, statistical judgment prioritization, and machine learning techniques. Further, the disclosed system may be configured for the presentation of topic filters in a GUI for filtering documents (e.g. regulatory documents) and receiving feedback from users of the GUI in order to improve the topic classification. Further, the disclosed system may be configured for providing a specialized judgment interface configurable for a wide variety of human judgment tasks relevant to the semantics of regulatory documents in the financial domain. Further, the disclosed system may be configured for specialized queuing and sampling infrastructure designed to optimize both the performance of the learned models and the efficiency of the human judges.

Further, the disclosed system may be configured for loop classification. Filtering recent documents by topic is an important aspect of regulatory change management. Using a novel blend of expert task specification and assessment, human-driven real-time classification, statistical judgment prioritization, and the latest machine learning techniques, the disclosed system may apply filter attributes to both recent additions and historically-published documents found in our system. These filters are then made available to regulatory compliance workers using a proprietary web UI which also allows them to provide their expert feedback. Further, the disclosed system may be configured for the creation and validation of repeatable, consistent guidelines for human judgment tasks about classification problems, especially “topic” classification, but also other kinds of relevance. Further, the disclosed system may be configured for the rapid creation of training data in support of machine learning for document classification. Further, the disclosed system may include a specialized judgment interface configurable for a wide variety of human judgment tasks relevant to the semantics of regulatory documents in the financial domain. Further, the disclosed system may include a specialized queueing and sampling infrastructure designed to optimize both the performance of the learned models and the efficiency of the human judges. Further, the disclosed system may emphasize client-facing accuracy over learned-model accuracy. Further, the disclosed system may be associated with a flexible framework capable of supporting arbitrary document classification tasks.

Further, the disclosed system may be configured for generating the 3D visualization with multiple layers that may be represented in the shape of a cube. Further, individual cubes that may comprise the visualization may all represent individual documents. The documents in a particular layer on an axis may represent documents that may be of the same category. Further, each layer may include multiple documents, represented by individual cubes that may be linked to the primary document, or the agenda documents in a similar manner through citations. Further, each progressive layer may include multiple documents that may be linked to the primary document, or agenda document to a lesser degree, including a decreasing number of citations. Accordingly, the layers may include multiple documents that may be relevant to the primary document. Further, the relevance of documents contained in a layer may decrease with each progressing layer.

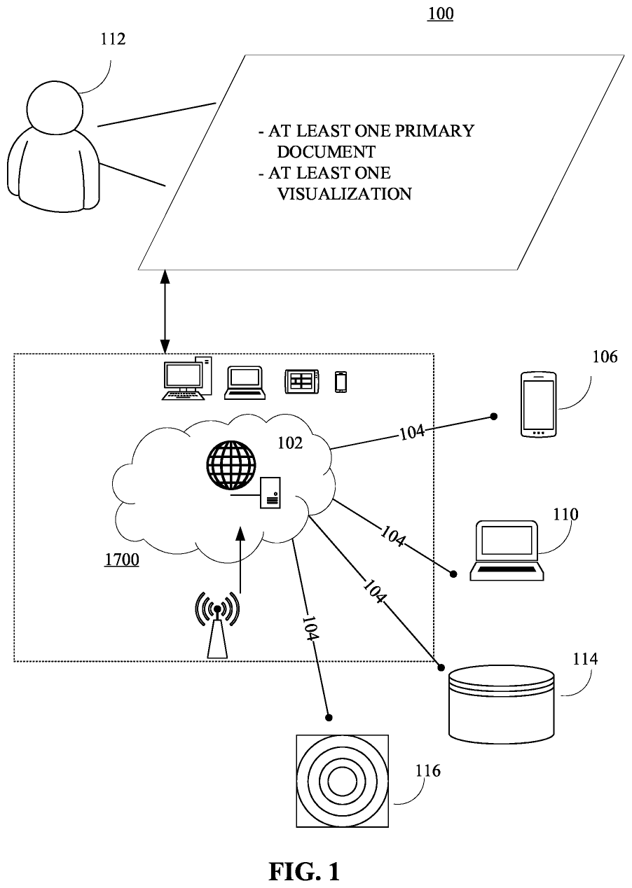

Referring now to figures, FIG. 1 is an illustration of an online platform 100 consistent with various embodiments of the present disclosure. By way of non-limiting example, the online platform 100 to facilitate generation of navigable visualizations of documents may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1700.

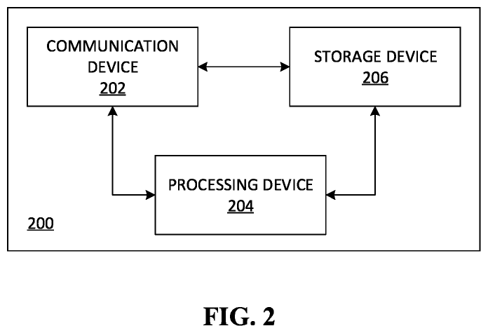

FIG. 2 is a block diagram of a system 200 for facilitating generation of navigable visualizations of documents, in accordance with some embodiments. Accordingly, the system 200 may include a communication device 202 configured for receiving at least one primary document from at least one user device. Further, the communication device 202 may be configured for transmitting at least one visualization to the at least one user device.

Further, the system 200 may include a processing device 204 communicatively coupled with the communication device 202. Further, the processing device 204 may be configured for analyzing the at least one primary document. Further, the processing device 204 may be configured for analyzing at least one reference document based on the at least one primary document. Further, the processing device 204 may be configured for identifying at least one relationship between the at least one primary document and the at least one reference document based on the analyzing of the at least one reference document. Further, the processing device 204 may be configured for establishing at least one link between the at least one primary document and the at least one reference document based on the at least one relationship. Further, the at least one link connects the at least one primary document and the at least one reference document. Further, the at least one link facilitates navigating between the at least one primary document and the at least one reference document. Further, the processing device 204 may be configured for generating the at least one visualization of the at least one primary document, the at least one reference document, and the at least one link based on the at least one primary document, the at least one reference document, and the at least one link.

Further, the system 200 may include a storage device 206 communicatively coupled with the processing device 204. Further, the storage device 206 may be configured for retrieving the at least one reference document based on the analyzing of the at least one primary document.

Further, in some embodiments, the processing device 204 may be configured for analyzing the at least one relationship between the at least one primary document and the at least one reference document. Further, the processing device 204 may be configured for determining at least one document attribute of at least one of the at least one primary document and the at least one reference document based on the analyzing of the at least one relationship. Further, the processing device 204 may be configured for determining at least one document visual cue for at least one of the at least one primary document and the at least one reference document based on the determining of the at least one document attribute. Further, the generating of the at least one visualization may be based on the determining of the at least one document visual cue.

Further, in some embodiments, at least one of the at least one primary document and the at least one reference document may include at least one document characteristic. Further, the at least one relationship corresponds to a similarity between the at least one primary document and the at least one reference document for the at least one document characteristic. Further, the at least one document characteristic may include content, references, citations, and categories of the documents.

Further, in some embodiments, the at least one document characteristic may include at least one reference. Further, the at least one reference document may include the at least one reference to and from the at least one primary document. Further, the processing device 204 may be configured for analyzing the at least one reference. Further, the processing device 204 may be configured for determining a number of references of the at least one reference based on the analyzing of the at least one reference. Further, the processing device 204 may be configured for determining at least one link visual cue for the at least one link based on the determining of the number of references. Further, the generating of the at least one visualization may be based on the determining of the at least one link visual cue.

Further, in some embodiments, the processing device 204 may be configured for analyzing the at least one document characteristic of at least one of the at least one primary document and the at least one reference document. Further, the processing device 204 may be configured for determining at least one first document visual cue for at least one of the at least one primary document and the at least one reference document based on the analyzing of the at least one document characteristic. Further, the generating of the at least one visualization may be based on the determining of the at least one first document visual cue.

Further, in some embodiments, the at least one visualization may include at least one of at least one primary document visual representation of the at least one primary document, at least one reference document visual representation of the at least one reference document, and at least one link visual representation of the at least one link

Further, in some embodiments, the at least one reference document visual representation may be spatially positioned in at least one first spatial position in a space in relation to at least one second spatial position of the at least one primary document visual representation in the space based on the at least one relationship between the at least one primary document and the at least one reference document.

Further, in some embodiments, the at least one first spatial position in relation to the at least one second spatial position may be characterized by at least one distance between the at least one second spatial position and the at least one first spatial position.

Further, the processing device 204 may be configured for determining a closeness between the at least one primary document and the at least one reference document in the at least one relationship based on the identifying of the at least one relationship. Further, the processing device 204 may be configured for determining the at least one distance between the at least one primary document visual representation and the at least one reference document visual representation based on the determining of the closeness. Further, the processing device 204 may be configured for determining the at least one first spatial position and the at least one second spatial position based on the determining of the at least one distance. Further, the generating of the at least one visualization may be based on the determining of the at least one first spatial position and the at least one second spatial position.

Further, in some embodiments, the communication device 202 may be configured for receiving at least one input data from the at least one user device. Further, the communication device 202 may be configured for transmitting at least one modified visualization to the at least one user device. Further, the processing device 204 may be configured for analyzing the at least one input data. Further, the processing device 204 may be configured for determining at least one action performable on the at least one visualization based on the analyzing of the at least one input data. Further, the processing device 204 may be configured for performing the at least one action on the at least one visualization. Further, the processing device 204 may be configured for generating the at least one modified visualization based on the performing. Further, the at least one action may include at least one navigating action for navigating the at least one visualization.

Further, in some embodiments, the at least one user device may include at least one sensor. Further, the at least one sensor may be configured for generating the at least one input data based on at least one gesture made by at least one user using at least a part of a body of the at least one user. Further, the receiving of the at least one input data may be based on the generating of the at least one input data.

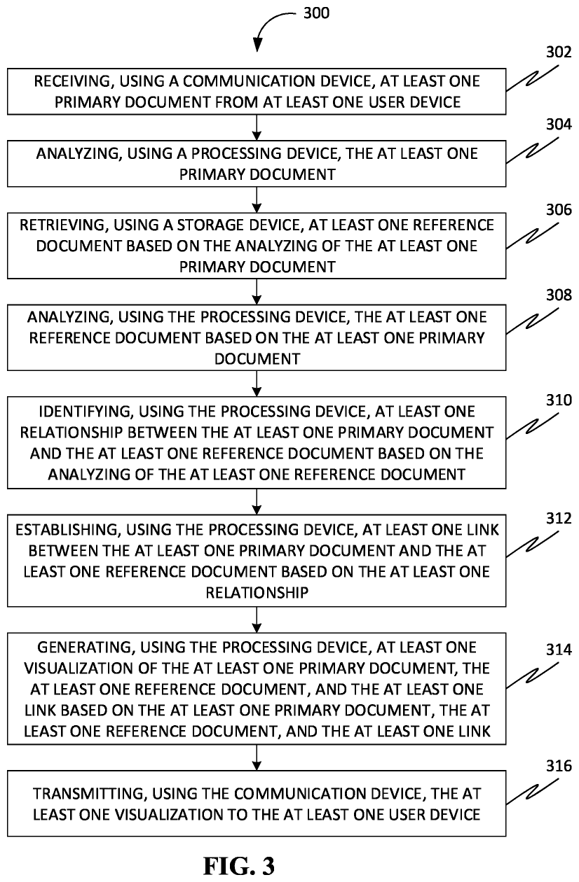

FIG. 3 is a flowchart of a method 300 for facilitating generation of navigable visualizations of documents, in accordance with some embodiments. Accordingly, at 302, the method 300 may include a step of receiving, using a communication device, at least one primary document from at least one user device. Further, the at least one primary document may include at least one regulatory document. Further, the at least one user device may include a computing device such as, but not limited to, a smartphone, a tablet, a smartwatch, a laptop, a desktop, and so on.

Further, at 304, the method 300 may include a step of analyzing, using a processing device, the at least one primary document.

Further, at 306, the method 300 may include a step of retrieving, using a storage device, at least one reference document based on the analyzing of the at least one primary document. Further, the at least one reference document may include at least one regulatory document.

Further, at 308, the method 300 may include a step of analyzing, using the processing device, the at least one reference document based on the at least one primary document.

Further, at 310, the method 300 may include a step of identifying, using the processing device, at least one relationship between the at least one primary document and the at least one reference document based on the analyzing of the at least one reference document.

Further, at 312, the method 300 may include a step of establishing, using the processing device, at least one link between the at least one primary document and the at least one reference document based on the at least one relationship. Further, the at least one link connects the at least one primary document and the at least one reference document. Further, the at least one link facilitates navigating between the at least one primary document and the at least one reference document.

Further, at 314, the method 300 may include a step of generating, using the processing device, at least one visualization of the at least one primary document, the at least one reference document, and the at least one link based on the at least one primary document, the at least one reference document, and the at least one link.

Further, at 316, the method 300 may include a step of transmitting, using the communication device, the at least one visualization to the at least one user device. Further, the at least one user device may be configured for presenting the at least one visualization

Further, in some embodiments, at least one of the at least one primary document and the at least one reference document may include at least one document characteristic. Further, the at least one relationship corresponds to a similarity between the at least one primary document and the at least one reference document for the at least one document characteristic. Further, the at least one document characteristic may include content, references, citations, and categories of the documents.

Further, in some embodiments, the at least one visualization may include at least one of at least one primary document visual representation of the at least one primary document, at least one reference document visual representation of the at least one reference document, and at least one link visual representation of the at least one link. Further, the at least one primary document visual representation may include at least one of a 2D object and a 3D object. Further, the 2D object may include a circle. Further, the 3D object may include a sphere. Further, the at least one reference document visual representation may include at least one of a 2D object and a 3D object. Further, the 2D object may include a circle. Further, the 3D object may include a sphere. Further, the at least one link visual representation may include at least one line.

Further, in some embodiments, the at least one reference document visual representation may be spatially positioned in at least one first spatial position in a space in relation to at least one second spatial position of the at least one primary document visual representation in the space based on the at least one relationship between the at least one primary document and the at least one reference document. Further, the space may include 2D space, 3D space, etc.

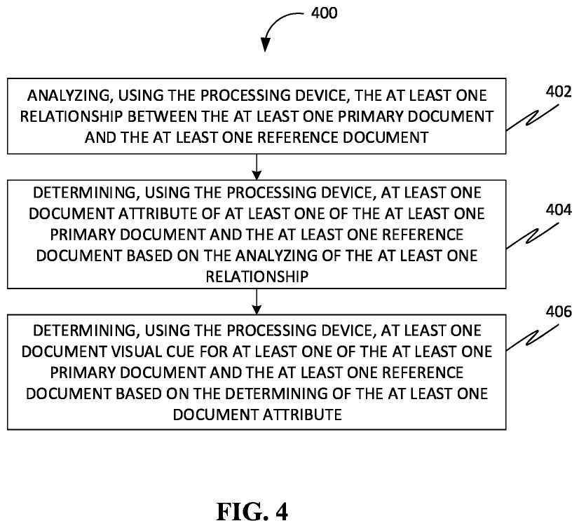

FIG. 4 is a flowchart of a method 400 for determining at least one document visual cue for facilitating the generation of the navigable visualizations of the documents, in accordance with some embodiments. Accordingly, at 402, the method 400 may include a step of analyzing, using the processing device, the at least one relationship between the at least one primary document and the at least one reference document.

Further, at 404, the method 400 may include a step of determining, using the processing device, at least one document attribute of at least one of the at least one primary document and the at least one reference document based on the analyzing of the at least one relationship. Further, the at least one document attribute may include a year, a jurisdiction, etc.

Further, at 406, the method 400 may include a step of determining, using the processing device, the at least one document visual cue for at least one of the at least one primary document and the at least one reference document based on the determining of the at least one document attribute. Further, the generating of the at least one visualization may be based on the determining of the at least one document visual cue. Further, the at least one document visual cue may include a shape, a color, etc.

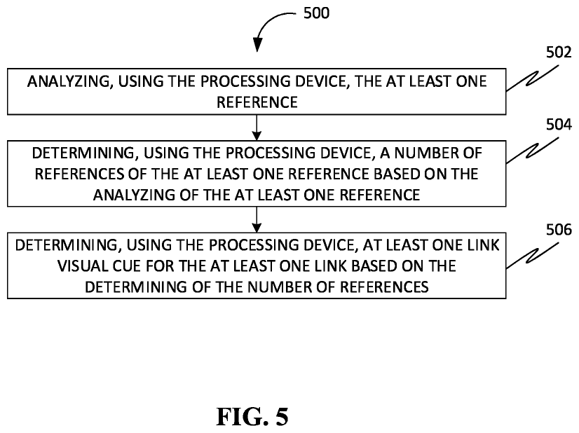

FIG. 5 is a flowchart of a method 500 for determining at least one link visual cue for facilitating the generation of the navigable visualizations of the documents, in accordance with some embodiments. Accordingly, the at least one document characteristic may include at least one reference. Further, the at least one reference document may include the at least one reference to and from the at least one primary document. Further, at 502, the method 500 may include a step of analyzing, using the processing device, the at least one reference. Further, the at least one document characteristic may include content, references, citations, and categories of the documents. Further, at 504, the method 500 may include a step of determining, using the processing device, a number of references of the at least one reference based on the analyzing of the at least one reference.

Further, at 506, the method 500 may include a step of determining, using the processing device, the at least one link visual cue for the at least one link based on the determining of the number of references. Further, the generating of the at least one visualization may be based on the determining of the at least one link visual cue. Further, the at least one link visual cue may include a shape, a color, etc.

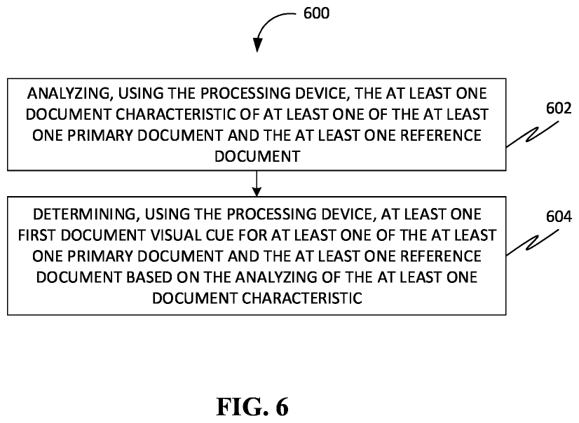

FIG. 6 is a flowchart of a method 600 for determining at least one first document visual cue for facilitating the generation of the navigable visualizations of the documents, in accordance with some embodiments. Accordingly, at 602, the method 600 may include a step of analyzing, using the processing device, the at least one document characteristic of at least one of the at least one primary document and the at least one reference document.

Further, at 604, the method 600 may include a step of determining, using the processing device, the at least one first document visual cue for at least one of the at least one primary document and the at least one reference document based on the analyzing of the at least one document characteristic. Further, the generating of the at least one visualization may be based on the determining of the at least one first document visual cue.

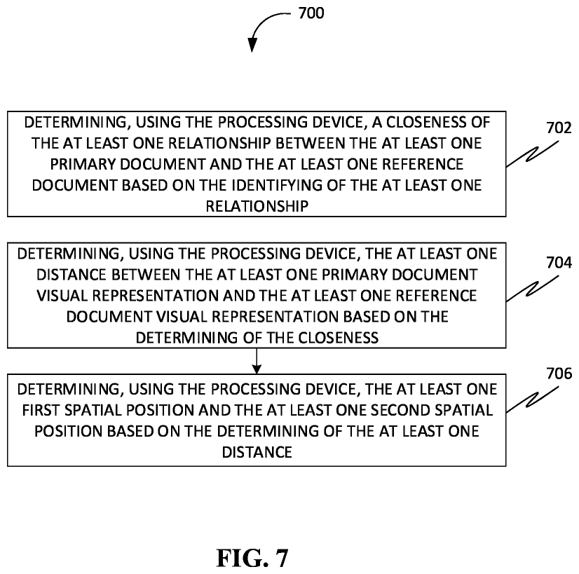

FIG. 7 is a flowchart of a method 700 for determining a closeness between the at least one primary document and the at least one reference document for facilitating the generation of the navigable visualizations of the documents, in accordance with some embodiments. Accordingly, the at least one first spatial position in relation to the at least one second spatial position may be characterized by at least one distance between the at least one second spatial position and the at least one first spatial position. Further, at 702, the method 700 may include a step of determining, using the processing device, the closeness between the at least one primary document and the at least one reference document in the at least one relationship based on the identifying of the at least one relationship.

Further, at 704, the method 700 may include a step of determining, using the processing device, the at least one distance between the at least one primary document visual representation and the at least one reference document visual representation based on the determining of the closeness.

Further, at 706, the method 700 may include a step of determining, using the processing device, the at least one first spatial position and the at least one second spatial position based on the determining of the at least one distance. Further, the generating of the at least one visualization may be based on the determining of the at least one first spatial position and the at least one second spatial position.

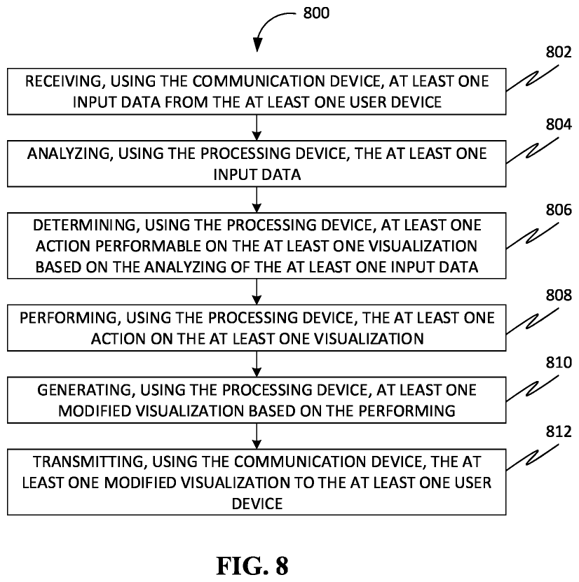

FIG. 8 is a flowchart of a method 800 for generating at least one modified visualization for facilitating the generation of the navigable visualizations of the documents, in accordance with some embodiments. Accordingly, at 802, the method 800 may include a step of receiving, using the communication device, at least one input data from the at least one user device.

Further, at 804, the method 800 may include a step of analyzing, using the processing device, the at least one input data.

Further, at 806, the method 800 may include a step of determining, using the processing device, at least one action performable on the at least one visualization based on the analyzing of the at least one input data. Further, the at least one action may include at least one navigating action for navigating the at least one visualization.

Further, at 808, the method 800 may include a step of performing, using the processing device, the at least one action on the at least one visualization.

Further, at 810, the method 800 may include a step of generating, using the processing device, at least one modified visualization based on the performing.

Further, at 812, the method 800 may include a step of transmitting, using the communication device, the at least one modified visualization to the at least one user device.

Further, in some embodiments, the at least one user device may include at least one sensor. Further, the at least one sensor may be configured for generating the at least one input data based on at least one gesture made by at least one user using at least a part of a body of the at least one user. Further, the receiving of the at least one input data may be based on the generating of the at least one input data.

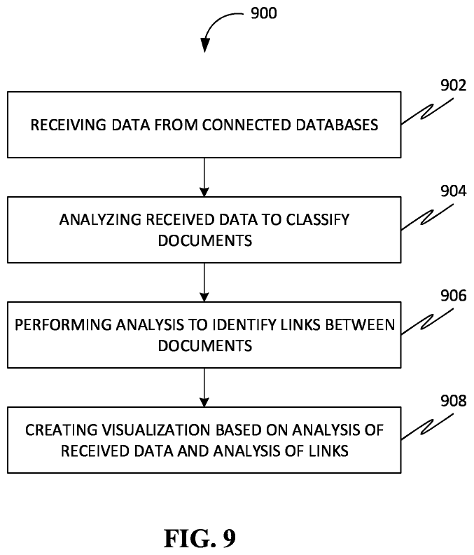

FIG. 9 is a flowchart of a method 900 for facilitating generation of visualizations for the navigable citation-based graph UI for regulatory documents, in accordance with some embodiments. Accordingly, the method 900 may include a step of receiving input from a user device. The input received from the user device may include primary documents that may need to be analyzed. Further, input from the user device may include inputs regarding the rendering of the visualizations. Further, the method 900 may include a step of analyzing the input. The input may be analyzed to determine a primary document with respect to which other documents may be analyzed to recognize links and citations. The primary document may further be analyzed by using scrapers, crawlers, and natural language processing techniques, and may be analyzed to determine the category and content of the document.

Further, at 902, the method 900 may include a step of receiving data from connected databases. The connected databases may include databases that may store regulatory documents, such as legal databases, medical databases, engineering databases, and so on. The data received may include regulatory documents and supporting data along with all the documents, such as the title, topic, and so on. The regulatory documents received may be related to the primary input document received from the user.

Further, at 904, the method 900 may include a step of analyzing the data to classify documents. The documents may be analyzed based on the title, headings, and subheadings, and may be classified. Further, the documents may be categorized, and sub-categorized, and sorted by appropriate categories, and sub-categories.

Further, at 906, the method 900 may include a step of performing analysis to identify the links between documents. The citations and co-citations between documents may be analyzed to determine document attributes such as genre, jurisdiction, and impact. Multiple algorithms, such as web scraping technologies, text extraction techniques, and crawling may be used to extract the data from and about the documents. The content of the documents may be analyzed to determine the links between documents. Relationships between documents may also be analyzed based on the subject matter or topics addressed in the documents. For instance, if multiple legal documents contain subject matter belonging to the same category, for instance relating to mergers between companies, the documents may cite references to other such legal documents detailing procedures or set precedents. The text of the documents may also be analyzed using natural language processing techniques. For instance, distributional semantics techniques, which may help in gauging similarity between documents based on the words used in the documents, including the used meaning of the words, may be used.

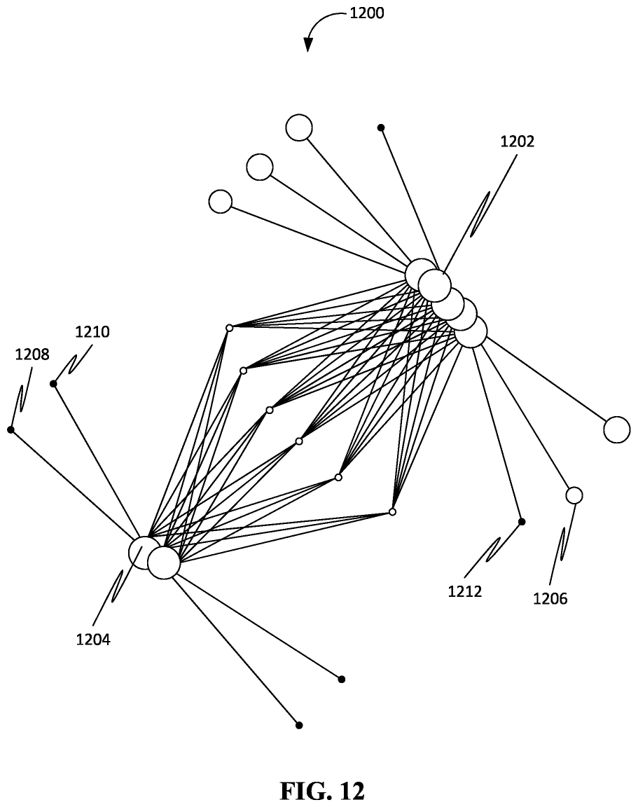

Further, at 908, the method 900 may include a step of creating a visualization based on analysis of the received data and analysis of the links between the documents. The visualizations created may differ based on the documents and the relationships and citations between documents. For instance, as shown in FIG. 12, multiple agenda items may be under scrutiny. The agenda items may be represented as blue circles 1202-1204 (as shown in FIG. 12). Further, the agenda items may be based on a single regulation document. The regulation documents may be represented as black circles 1206-1208 (as shown in FIG. 12). Accordingly, multiple legal references and citations may be made to the regulation documents in the agenda items. The references and the citations may be represented as grey lines. The thickness of the grey lines may differ based on the number of citations and legal references included in the agenda items to the regulations. Further, the rules under which the legal references may be made may also be visually depicted. Accordingly, the rules may be represented as orange circles 1210-1212 (as shown in FIG. 12). Further, the visualizations may also be rendered in a different manner based on analysis of user input. The user may select a different manner in which to depict the visualizations, for instance through a predefined theme, that may represent the documents, and the citations in the documents in a different manner. The visualizations may also represent attributes of the regulatory documents such as genre, jurisdiction, and impact using visual cues such as shape, size, and color.

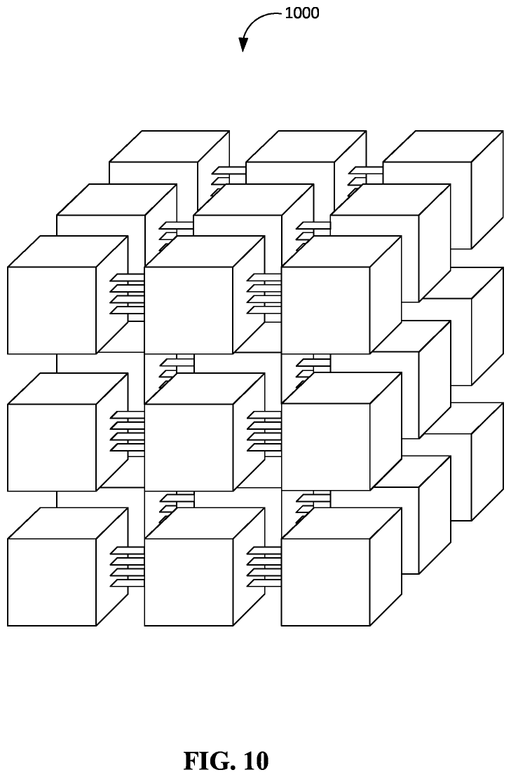

FIG. 10 is an illustration of a visualization 1000 of a navigable citation-based graph UI of regulatory documents, in accordance with some embodiments. Accordingly, the visualization 1000 may include a 3D visualization, representing a visualization rendered by the disclosed system for a navigation citation-based graph UI.

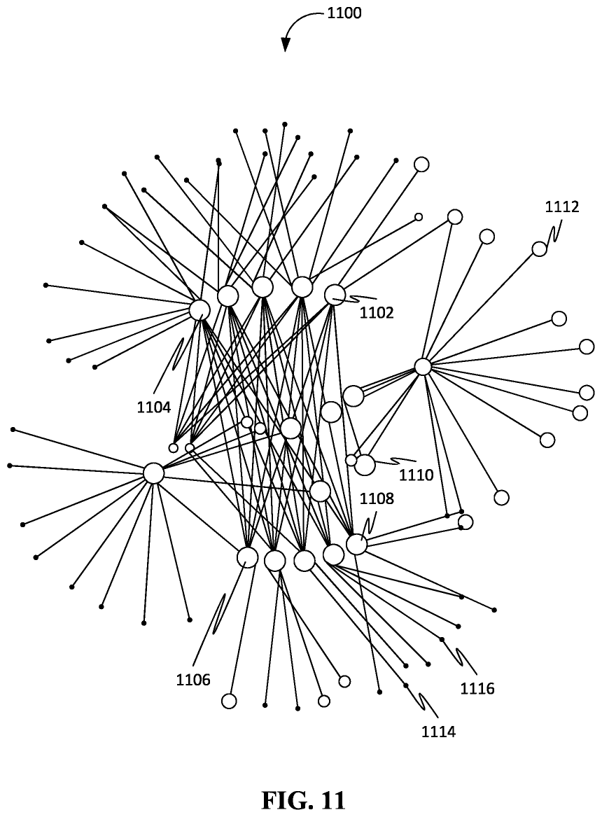

FIG. 11 is an illustration of a visualization 1100 of a navigable citation-based graph UI of regulatory documents, in accordance with some embodiments. Accordingly, the visualization 1100 may include circles to represent the regulatory documents. Further, the lines may represent the relationship between the regulatory documents through citations, and accordingly the relevance of the regulatory documents. Further, the visualization 1100 shows multiple agenda items that may be under scrutiny. Further, the agenda items may be represented as blue circles 1102-1108. Further, the agenda items may be based on multiple regulation documents. The multiple regulation documents may be represented as black circles 1110-1112. Accordingly, multiple legal references and citations may be made to the regulation documents in the agenda items. The references and the citations may be represented as grey lines. The thickness of the grey lines may differ based on the number of citations and legal references included in the agenda items to the regulations. Further, the rules under which the legal references may be made may also be visually depicted. Accordingly, the rules may be represented as orange circles 1114-1116. The displayed links between the regulatory documents in the visualization 1100 may help in inspecting the impact and similarity of all the regulatory documents linking the agenda items.

FIG. 12 is an illustration of a visualization 1200 of a navigable citation-based graph UI of regulatory documents, in accordance with some embodiments. Accordingly, agenda items may be represented as blue circles 1202-1204. Further, the agenda items may be based on multiple regulation documents. Further, multiple regulation documents may be represented as black circles 1206-1208. Accordingly, rules may be represented as orange circles 1210-1212.

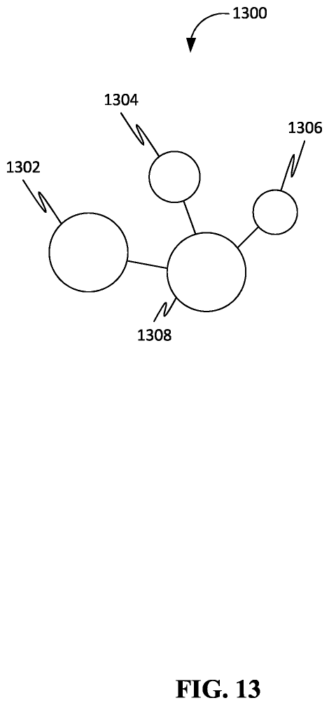

FIG. 13 is an illustration of a visualization 1300 of a document, in accordance with some embodiments. Accordingly, the visualization 1300 may include a plurality of visual representations 1302-1308. Further, a visual representation 1302 of the plurality of visual representations 1302-1308 may include news. Further, a visual representation 1304 of the plurality of visual representations 1302-1308 may include notices. Further, a visual representation 1306 of the plurality of visual representations 1302-1308 may include CFPB. Further, a visual representation 1308 of the plurality of visual representations 1302-1308 may include final rules.

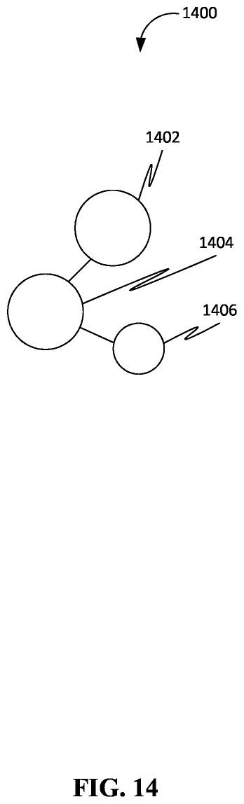

FIG. 14 is an illustration of a visualization 1400 of a document, in accordance with some embodiments. Accordingly, the visualization 1400 may include a plurality of visual representations 1402-1406. Further, a visual representation 1402 of the plurality of visual representations 1402-1406 may include enforcement. Further, a visual representation 1406 of the plurality of visual representations 1402-1406 may include agency updates. Further, a visual representation 1404 of the plurality of visual representations 1402-1406 may include FINRA.

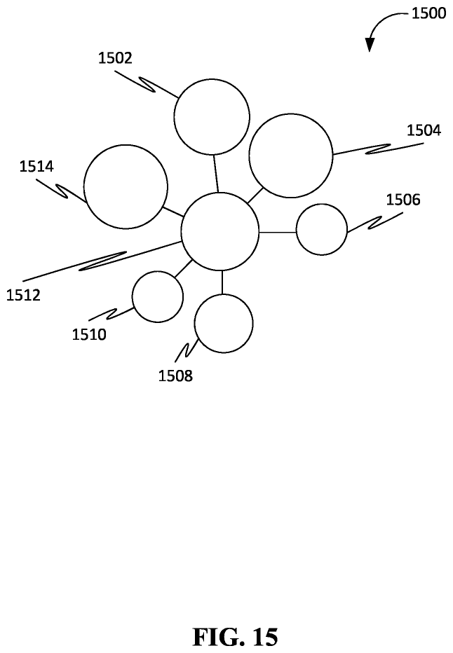

FIG. 15 is an illustration of a visualization 1500 of a document, in accordance with some embodiments. Accordingly, the visualization 1500 may include a plurality of visual representations 1502-1514. Further, a visual representation 1502 of the plurality of visual representations 1502-1514 may include proposed rules. Further, a visual representation 1504 of the plurality of visual representations 1502-1514 may include enforcements. Further, a visual representation 1506 of the plurality of visual representations 1502-1514 may include agency updates. Further, a visual representation 1508 of the plurality of visual representations 1502-1514 may include news. Further, a visual representation 1510 of the plurality of visual representations 1502-1514 may include notices. Further, a visual representation 1512 of the plurality of visual representations 1502-1514 may include FFIEC. Further, a visual representation 1514 of the plurality of visual representations 1502-1514 may include final rule.

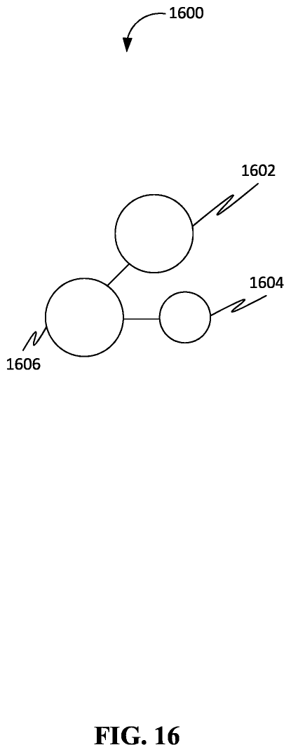

FIG. 16 is an illustration of a visualization 1600 of a document, in accordance with some embodiments. Accordingly, the visualization 1600 may include a plurality of visual representations 1602-1606. Further, a visual representation 1602 of the plurality of visual representations 1602-1606 may include enforcement. Further, a visual representation 1604 of the plurality of visual representations 1602-1606 may include agency updates. Further, a visual representation 1606 of the plurality of visual representations 1602-1606 may include NYSE.

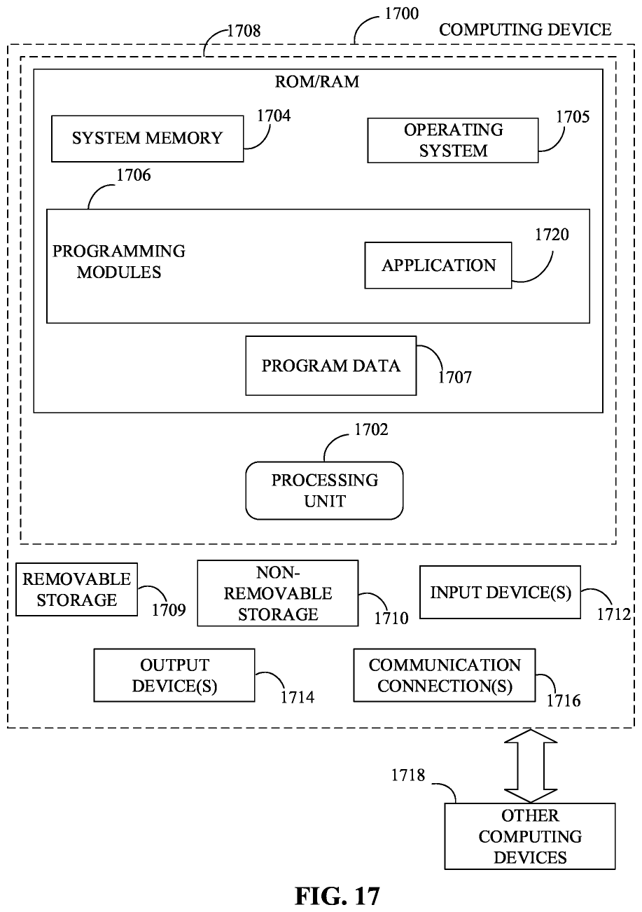

With reference to FIG. 17, a system consistent with an embodiment of the disclosure may include a computing device or cloud service, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random-access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700's operation. In one embodiment, programming modules 1706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710. Computer storage media may include volatile and non-volatile, removable and non-removable media implemented in any method or technology for storage of information, such as computer-readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, a location sensor, a camera, a biometric sensor, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1704, including operating system 1705. While executing on processing unit 1702, programming modules 1706 (e.g., application 1720 such as a media player) may perform processes including, for example, one or more stages of methods, algorithms, systems, applications, servers, databases as described above. The aforementioned process is an example, and processing unit 1702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating generation of navigable visualizations of documents, the method comprising:
receiving, using a communication device, at least one primary document from at least one user device;
analyzing, using a processing device, the at least one primary document;
retrieving, using a storage device, at least one reference document based on the analyzing of the at least one primary document;
analyzing, using the processing device, the at least one reference document based on the at least one primary document;
identifying, using the processing device, at least one relationship between the at least one primary document and the at least one reference document based on the analyzing of the at least one reference document;
establishing, using the processing device, at least one link between the at least one primary document and the at least one reference document based on the at least one relationship, wherein the at least one link connects the at least one primary document and the at least one reference document, wherein the at least one link facilitates navigating between the at least one primary document and the at least one reference document;
generating, using the processing device, at least one visualization of the at least one primary document, the at least one reference document, and the at least one link based on the at least one primary document, the at least one reference document, and the at least one link; and
transmitting, using the communication device, the at least one visualization to the at least one user device.

2. The method of claim 1 further comprising:
analyzing, using the processing device, the at least one relationship between the at least one primary document and the at least one reference document;
determining, using the processing device, at least one document attribute of at least one of the at least one primary document and the at least one reference document based on the analyzing of the at least one relationship; and
determining, using the processing device, at least one document visual cue for at least one of the at least one primary document and the at least one reference document based on the determining of the at least one document attribute, wherein the generating of the at least one visualization is based on the determining of the at least one document visual cue.

3. The method of claim 1, wherein at least one of the at least one primary document and the at least one reference document comprises at least one document characteristic, wherein the at least one relationship corresponds to a similarity between the at least one primary document and the at least one reference document for the at least one document characteristic.

4. The method of claim 3, wherein the at least one document characteristic comprises at least one reference, wherein the at least one reference document comprises the at least one reference to and from the at least one primary document, wherein the method further comprises:
analyzing, using the processing device, the at least one reference;
determining, using the processing device, a number of references of the at least one reference based on the analyzing of the at least one reference; and
determining, using the processing device, at least one link visual cue for the at least one link based on the determining of the number of references, wherein the generating of the at least one visualization is based on the determining of the at least one link visual cue.

5. The method of claim 3 further comprising:
analyzing, using the processing device, the at least one document characteristic of at least one of the at least one primary document and the at least one reference document; and
determining, using the processing device, at least one first document visual cue for at least one of the at least one primary document and the at least one reference document based on the analyzing of the at least one document characteristic, wherein the generating of the at least one visualization is based on the determining of the at least one first document visual cue.

6. The method of claim 1, wherein the at least one visualization comprises at least one of at least one primary document visual representation of the at least one primary document, at least one reference document visual representation of the at least one reference document, and at least one link visual representation of the at least one link.

7. The method of claim 6, wherein the at least one reference document visual representation is spatially positioned in at least one first spatial position in a space in relation to at least one second spatial position of the at least one primary document visual representation in the space based on the at least one relationship between the at least one primary document and the at least one reference document.

8. The method of claim 7, wherein the at least one first spatial position in relation to the at least one second spatial position is characterized by at least one distance between the at least one second spatial position and the at least one first spatial position, wherein the method further comprises:
determining, using the processing device, a closeness between the at least one primary document and the at least one reference document in the at least one relationship based on the identifying of the at least one relationship;
determining, using the processing device, the at least one distance between the at least one primary document visual representation and the at least one reference document visual representation based on the determining of the closeness; and
determining, using the processing device, the at least one first spatial position and the at least one second spatial position based on the determining of the at least one distance, wherein the generating of the at least one visualization is based on the determining of the at least one first spatial position and the at least one second spatial position.

9. The method of claim 1 further comprising:
receiving, using the communication device, at least one input data from the at least one user device;
analyzing, using the processing device, the at least one input data;
determining, using the processing device, at least one action performable on the at least one visualization based on the analyzing of the at least one input data;
performing, using the processing device, the at least one action on the at least one visualization;
generating, using the processing device, at least one modified visualization based on the performing; and
transmitting, using the communication device, the at least one modified visualization to the at least one user device.

10. The method of claim 9, wherein the at least one user device comprises at least one sensor, wherein the at least one sensor is configured for generating the at least one input data based on at least one gesture made by at least one user using at least a part of a body of the at least one user, wherein the receiving of the at least one input data is based on the generating of the at least one input data.

11. A system for facilitating generation of navigable visualizations of documents, the system comprising:
a communication device configured for:
receiving at least one primary document from at least one user device; and
transmitting at least one visualization to the at least one user device;
a processing device communicatively coupled with the communication device, wherein the processing device is configured for:
analyzing the at least one primary document;
analyzing at least one reference document based on the at least one primary document;
identifying at least one relationship between the at least one primary document and the at least one reference document based on the analyzing of the at least one reference document;
establishing at least one link between the at least one primary document and the at least one reference document based on the at least one relationship, wherein the at least one link connects the at least one primary document and the at least one reference document, wherein the at least one link facilitates navigating between the at least one primary document and the at least one reference document; and
generating the at least one visualization of the at least one primary document, the at least one reference document, and the at least one link based on the at least one primary document, the at least one reference document, and the at least one link; and
a storage device communicatively coupled with the processing device, wherein the storage device is configured for retrieving the at least one reference document based on the analyzing of the at least one primary document.

12. The system of claim 11, wherein the processing device is further configured for:
analyzing the at least one relationship between the at least one primary document and the at least one reference document;
determining at least one document attribute of at least one of the at least one primary document and the at least one reference document based on the analyzing of the at least one relationship; and
determining at least one document visual cue for at least one of the at least one primary document and the at least one reference document based on the determining of the at least one document attribute, wherein the generating of the at least one visualization is based on the determining of the at least one document visual cue.

13. The system of claim 11, wherein at least one of the at least one primary document and the at least one reference document comprises at least one document characteristic, wherein the at least one relationship corresponds to a similarity between the at least one primary document and the at least one reference document for the at least one document characteristic.

14. The system of claim 13, wherein the at least one document characteristic comprises at least one reference, wherein the at least one reference document comprises the at least one reference to and from the at least one primary document, wherein the processing device is further configured for:
analyzing the at least one reference;
determining a number of references of the at least one reference based on the analyzing of the at least one reference; and
determining at least one link visual cue for the at least one link based on the determining of the number of references, wherein the generating of the at least one visualization is based on the determining of the at least one link visual cue.

15. The system of claim 13, wherein the processing device is further configured for:
analyzing the at least one document characteristic of at least one of the at least one primary document and the at least one reference document; and
determining at least one first document visual cue for at least one of the at least one primary document and the at least one reference document based on the analyzing of the at least one document characteristic, wherein the generating of the at least one visualization is based on the determining of the at least one first document visual cue.

16. The system of claim 11, wherein the at least one visualization comprises at least one of at least one primary document visual representation of the at least one primary document, at least one reference document visual representation of the at least one reference document, and at least one link visual representation of the at least one link.

17. The system of claim 16, wherein the at least one reference document visual representation is spatially positioned in at least one first spatial position in a space in relation to at least one second spatial position of the at least one primary document visual representation in the space based on the at least one relationship between the at least one primary document and the at least one reference document.

18. The system of claim 17, wherein the at least one first spatial position in relation to the at least one second spatial position is characterized by at least one distance between the at least one second spatial position and the at least one first spatial position, wherein the processing device is further configured for:
determining a closeness between the at least one primary document and the at least one reference document in the at least one relationship based on the identifying of the at least one relationship;
determining the at least one distance between the at least one primary document visual representation and the at least one reference document visual representation based on the determining of the closeness; and
determining the at least one first spatial position and the at least one second spatial position based on the determining of the at least one distance, wherein the generating of the at least one visualization is based on the determining of the at least one first spatial position and the at least one second spatial position.

19. The system of claim 11, wherein the communication device is further configured for:
receiving at least one input data from the at least one user device; and
transmitting at least one modified visualization to the at least one user device, wherein the processing device is further configured for:
analyzing the at least one input data;
determining at least one action performable on the at least one visualization based on the analyzing of the at least one input data;
performing the at least one action on the at least one visualization; and
generating the at least one modified visualization based on the performing.

20. The system of claim 19, wherein the at least one user device comprises at least one sensor, wherein the at least one sensor is configured for generating the at least one input data based on at least one gesture made by at least one user using at least a part of a body of the at least one user, wherein the receiving of the at least one input data is based on the generating of the at least one input data.
